(19) United States
(12) Patent Application Publication
(10) Pub. No.: US 2026/0320375 A1
(43) Pub. Date: Oct. 15, 2026

(54) LEARNING APPARATUS, CONVERSION APPARATUS, LEARNING METHOD, CONVERSION METHOD AND PROGRAM

(71) Applicant: NTT, Inc., Tokyo (JP)

(72) Inventors: Daisuke NIIZUMI, Musashino-shi (JP); Daiki TAKEUCHI, Musashino-shi (JP); Yasunori OISHI, Musashino-shi (JP); Noboru HARADA, Musashino-shi (JP); Kunio KASHINO, Musashino-shi (JP)

(73) Assignee: NTT, Inc., Tokyo (JP)

(21) Appl. No.: 19/104,325

(22) PCT Filed: Sep. 6, 2022
(86) PCT No.: PCT/JP2022/033441

§ 371 Date: Feb. 17, 2025

(51) Int. Cl. G06N 3/08

(52) U.S. Cl. CPC G06N 3/08

(57) ABSTRACT

An aspect of the present invention is a learning device including a control unit that obtains, by learning, target representation encoding process of encoding representation of data to be converted into target representation that is predetermined representation determined in advance, in which the control unit executes first representation encoding process of encoding representation of a processing target into target representation using first data that is data obtained by removing masked data from the 0-th data that is data represented by a tensor as the processing target, masked data representation prediction processing of predicting target representation of the masked data on the basis of a result of the first representation encoding process, second representation encoding process of encoding representation of second data that is part or all of the masked data into target representation, and updating processing of updating content of the first representation encoding process so as to reduce a difference between a result of the masked data representation prediction processing and a result of the second representation prediction processing, and, the first representation prediction processing at a time point at which a predetermined condition regarding end of update is satisfied is the target representation prediction processing.

### TECHNICAL FIELD

The present invention relates to a learning apparatus, a conversion apparatus, a learning method, a conversion method, and a program.

### BACKGROUND ART

A technique for generating a mathematical model for converting representation of data to be converted into predetermined representation determined in advance using machine learning is known. The predetermined representation determined in advance is, for example, representation required in a downstream task. Note that converting the representation of the data to be converted into the predetermined representation determined in advance means encoding processing for converting the data to be converted into data represented in the predetermined representation determined in advance.

### CITATION LIST

### Non Patent Literature

Non Patent Literature 1: Kaiming He, et al., “Masked autoencoders are scalable vision learners,” arXiv preprint arXiv: 2111.06377, 2021.
Non Patent Literature 2: A. Baevski, et al., “data2vec: A general framework for self-supervised learning in speech, vision and language,” in arXiv preprint arXiv: 2202.03555, 2022.

### SUMMARY OF INVENTION

### Technical Problem

Masked autoencoders (MAE) and data2vec have been proposed as such techniques. All of these are techniques for masking part of input information and performing learning using the result. However, in some cases, accuracy of conversion is poor in the both techniques.

In view of the above circumstances, an object of the present invention is to provide a technique for improving accuracy of converting representation of data to be converted into predetermined representation.

### Solution to Problem

An aspect of the present invention is a learning device including a control unit that obtains, by learning, target representation encoding processing that is processing of converting representation of data to be converted into target representation that is predetermined representation determined in advance, in which the control unit executes first representation encoding processing of converting representation of a processing target into target representation using first data that is data obtained by removing masked data that is part of 0-th data from the 0-th data that is data represented by a tensor as the processing target, masked data representation prediction processing of predicting target representation of the masked data on the basis of a result of the first representation encoding processing, second representation encoding processing of converting representation of second data into target representation on the basis of the second data that is part or all of the masked data, and updating processing of updating content of the first representation encoding processing, the masked data representation prediction processing, and the second representation encoding processing so as to reduce a difference between a result of the masked data representation prediction processing and a result of the second representation encoding processing, and the first representation encoding processing at a time point at which a predetermined condition regarding end of update is satisfied is the target representation encoding processing.

An aspect of the present invention is a conversion device comprising: a conversion target acquisition unit that acquires data for which representation is to be converted into target representation that is predetermined representation determined in advance; and an representation conversion unit converts representation of the data acquired by the conversion target acquisition unit by using the target representation encoding processing obtained by a learning device comprising: a control unit that obtains, by learning, target representation encoding processing that is processing of converting representation of data to be converted into target representation that is predetermined representation determined in advance, wherein the control unit executes first representation encoding processing of converting representation of a processing target into target representation using first data that is data obtained by removing masked data that is part of 0-th data from the 0-th data that is data represented by a tensor as the processing target, masked data representation prediction processing of predicting target representation of the masked data on a basis of a result of the first representation encoding processing, second representation encoding processing of converting representation of second data into target representation on a basis of the second data that is part or all of the masked data, and updating processing of updating content of the first representation encoding processing, the masked data representation prediction processing, and the second representation encoding processing so as to reduce a difference between a result of the masked data representation prediction processing and a result of the second representation encoding processing, and the first representation encoding processing at a time point at which a predetermined condition regarding end of update is satisfied is the target representation encoding processing.

An aspect of the present invention is a learning method including a control step of obtaining, by learning, target representation encoding processing that is processing of converting representation of data to be converted into target representation that is predetermined representation determined in advance, in which the control step executes first representation encoding processing of converting representation of a processing target into target representation using first data that is data obtained by removing masked data that is part of 0-th data from the 0-th data that is data represented by a tensor as the processing target, masked data representation prediction processing of predicting target representation of the masked data on the basis of a result of the first representation encoding processing, second representation encoding processing of converting representation of second data into target representation on the basis of the second data that is part or all of the masked data, and updating processing of updating content of the first representation encoding processing, the masked data representation prediction processing, and the second representation encoding processing so as to reduce a difference between a result of the masked data representation prediction processing and a result of the second representation encoding processing, and the first representation encoding processing at a time point at which a predetermined condition regarding end of update is satisfied is the target representation encoding processing.

An aspect of the present invention is a conversion method comprising: a conversion target acquisition step of acquiring data for which representation is to be converted into target representation that is predetermined representation determined in advance; and an representation conversion step of converting representation of the data acquired in the conversion target acquisition step by using the target representation encoding processing obtained by a learning method, comprising: a control step of obtaining, by learning, target representation encoding processing that is processing of converting representation of data to be converted into target representation that is predetermined representation determined in advance, wherein the control step executes first representation encoding processing of converting representation of a processing target into target representation using first data that is data obtained by removing masked data that is part of 0-th data from the 0-th data that is data represented by a tensor as the processing target, masked data representation prediction processing of predicting the target representation of the masked data on a basis of a result of the first representation encoding processing, second representation encoding processing of converting representation of second data into target representation on a basis of the second data that is part or all of the masked data, and updating processing of updating content of the first representation encoding processing, the masked data representation prediction processing, and the second representation encoding processing so as to reduce a difference between a result of the masked data representation prediction processing and a result of the second representation encoding processing, and the first representation encoding processing at a time point at which a predetermined condition regarding end of update is satisfied is the target representation encoding processing.

An aspect of the present invention is a program for causing a computer to function as any of the learning device described above and the conversion device described above.

### Advantageous Effects of Invention

According to the present invention, it is possible to improve accuracy of converting representation of data to be converted into predetermined representation.

### BRIEF DESCRIPTION OF DRAWINGS

FIG. 1 is a view illustrating an example of a configuration of an representation conversion system according to an embodiment.

FIG. 2 is an explanatory diagram for explaining a patch according to the embodiment.

FIG. 3 is an explanatory diagram for explaining outline of flow of processing to be executed by a learning unit according to the embodiment.

FIG. 4 is a flowchart indicating an example of flow of learning processing to be executed by the learning unit according to the embodiment.

FIG. 5 is a view illustrating an example of a hardware configuration of a learning device according to the embodiment.

FIG. 6 is a view illustrating an example of a configuration of a control unit according to the embodiment.

FIG. 7 is a view illustrating an example of a hardware configuration of a conversion device according to the embodiment.

FIG. 8 is a view illustrating an example of a configuration of the control unit according to the embodiment.

FIG. 9 is a flowchart indicating an example of flow of processing to be executed by the conversion device according to the embodiment.

FIG. 10 is a view indicating an example of results of experiments according to the embodiment.

### DESCRIPTION OF EMBODIMENTS

### Embodiment

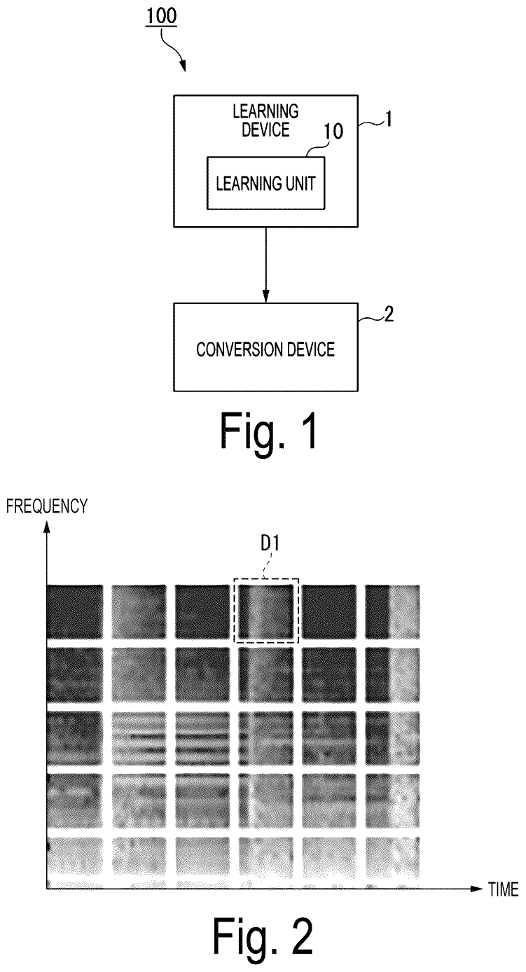

FIG. 1 is a view illustrating an example of a configuration of an representation conversion system 100 according to an embodiment. The representation conversion system 100 includes a learning device 1 and a conversion device 2. The learning device 1 obtains, by learning, processing (hereinafter, referred to as “target representation encoding processing”) of converting representation of data to be converted into predetermined representation (hereinafter, referred to as “target representation”) determined in advance.

Note that converting representation of data into the target representation means encoding processing for converting data to be encoded into data represented in the target representation. Thus, converting representation of data to be converted into the target representation means encoding processing for converting data to be converted into data represented in the target representation.

The target representation is, for example, representation embedding. The target representation is, for example, representation of 768 floating point values.

The target representation may be, for example, representation of 1024 floating point values. The target representation may be, for example, representation of 2048 floating point values. The representation encoding processing is one type of a learning model.

The data to be converted may be any data as long as the data is obtained on the basis of any of image data, acoustic signal data, natural language data, and general time-series data and is represented by a tensor. Thus, the data to be converted may be, for example, image data, a spectrogram of acoustic signal data, or a sequence (hereinafter, referred to as a “natural language sequence”) including words as samples and in which each word is represented by an M-dimensional vector (M is a natural number equal to or greater than 1). The data to be converted may be, for example, general time-series data in which symbols or numbers other than characters are represented by vectors.

The spectrogram of the acoustic signal data is obtained on the basis of the acoustic signal data. The natural language sequence is obtained on the basis of the natural language data.

The learning device 1 includes a learning unit 10. The learning unit 10 executes first representation encoding processing, masked data representation prediction processing, second representation encoding processing, and updating processing. Note that content of the first representation encoding processing, the masked data representation prediction processing, and the second representation encoding processing may have been updated in advance by transfer learning, or the like, for example.

The first representation encoding processing is processing of converting representation of a processing target into the target representation. A processing target of the first representation encoding processing when the first representation encoding processing is executed by the learning unit 10 is first data.

The first data is data obtained by removing masked data that is part of the 0-th data from the 0-th data. The 0-th data is data represented by a tensor.

The 0-th data is, for example, a tensor expressing original data in a state where data has been divided into patches, a tensor also having data position information which is information indicating a position of each patch, and a tensor having the tensor as an element. The 0-th data is, for example, a matrix having as an element, a vector of each patch that is a result of the tensor to be divided being divided into patches. The division into patches is processing of dividing a division target into parts called patches.

The original data is data corresponding to a conversion target and is data represented by a tensor. Thus, in a case where the conversion target is image data, the original data is image data.

In a case where the data to be converted is data obtained on the basis of acoustic signal data, the original data is data obtained on the basis of the acoustic signal data and is data represented by a tensor. Such data is, for example, a spectrogram of the acoustic signal data.

In a case where the data to be converted is data obtained on the basis of natural language data, the original data is data obtained on the basis of the natural language data and is data represented by a tensor. Such data is, for example, a natural language sequence. In a case where the data to be converted is data obtained on the basis of general time-series data, the original data is data obtained on the basis of the general time-series data and is data represented by a tensor. Such data is, for example, a time series of numerical values such as a stock price and a temperature.

As described above, the original data is any one of the image data, the data obtained on the basis of the acoustic signal data and represented by a tensor, the data obtained on the basis of the natural language data and represented by a tensor, and the data obtained on the basis of the general time-series data and represented by a tensor.

One element of the tensor of the 0-th data indicates information regarding one patch. One patch includes one or more elements of a tensor expressing the original data. One element is, for example, data represented by a 768 dimensional vector. Note that the position of the patch is a position of the element corresponding to each patch in the 0-th data.

Note that division into patches and provision of the data position information may be executed by the learning device 1. In other words, processing of obtaining the 0-th data on the basis of the original data (hereinafter, referred to as “0-th data generation processing”) may be executed by the learning device 1 or may be executed by another device different from the learning device 1. The 0-th data may be, for example, the original data itself. In such a case, the 0-th data generation processing does not have to be executed.

FIG. 2 is an explanatory diagram for explaining the patch according to the embodiment. Specifically, FIG. 2 is an explanatory diagram for explaining the patch in a case where the conversion target is acoustic signal data. More specifically, the example of FIG. 2 is an explanatory diagram for explaining the patch using an example of a case where the acoustic signal data is a spectrogram including a frequency axis and a time axis.

In FIG. 2, the spectrogram is divided into a plurality of rectangular sections having the same size in both the frequency axis and the time axis to illustrate the patch. The patch is data expressing each divided section with a vector. For example, data expressing each section of a region D1 in FIG. 2 is one patch.

The patch is, for example, a vector indicating a pixel value of each pixel included in the corresponding section. The number of elements of the vector expressing the patch is the same regardless of the vector. The number of elements of the vector expressing the patch only requires to be the same regardless of the vector, and for example, may be proportional to the number of pixels included in the section. A coefficient of proportion may be 1 or does not have to be 1. In a case where the coefficient of proportion is not 1, a value of each element may be, for example, a value obtained by interpolation.

For example, in a case where the number of pixels included in one patch is 256 and the coefficient is 3, the patch is a 768 dimensional vector.

The data position information is, for example, a vector having the same number of dimensions as the number of dimensions of a vector expressing the patch. Each element of the 0-th data is, for example, a vector represented by a vector sum of a vector expressing the patch and a vector indicating the data position information.

In the example of FIG. 2, the position of each patch is indicated by respective positions in the frequency axis direction and in the time axis direction. Thus, in the example of FIG. 2, the 0-th data is a matrix having vectors as elements. In the example of FIG. 2, in a case where the patch is a vector having the number of elements proportional to the number of pixels, the 0-th data is a matrix having tensors of the first order as elements. It goes without saying that a tensor of the first order is a vector and a tensor of the second order is a matrix. Incidentally, the tensor of the 0-th order is a scalar.

Note that, in a case where the coefficient of proportion is greater than 1, it is possible to prevent increase in missing of information when data is encoded in various kinds of processing such as the first representation encoding processing.

Thus, the 0-th data is obtained on the basis of the original data. Then, a value of one element of the tensor expressing the 0-th data expresses each section in a case where the tensor expressing the original data is divided according to a predetermined rule, by a vector. A dimension of the vector expressing the section is, for example, larger than the number of elements included in the section and the number of elements of the tensor expressing the original data.

The description returns to FIG. 1. The masked data representation prediction processing is processing of predicting the target representation of the masked data on the basis of a result of the first representation encoding processing. The second representation encoding processing is processing of converting representation of second data into the target representation on the basis of the second data that is part or all of the masked data. The updating processing is processing of updating content of the first representation encoding processing, the masked data representation prediction processing, and the second representation encoding processing so as to reduce a difference (hereinafter, referred to as a “conversion error”) between a result of the masked data representation prediction processing and a result of the second representation encoding processing.

The conversion error may be a mean square error (MSE) between the result of the masked data representation prediction processing and the result of the second representation encoding processing or may be L1 which is an average absolute value of the difference.

As described above, the learning unit 10 performs learning of the first representation encoding processing and the masked data representation prediction processing so as to reduce a difference between the target representation of the masked data obtained on the basis of data obtained by removing the masked data and the target representation of the masked data obtained on the basis of part or all of the masked data.

The conversion device 2 converts representation of data to be processed by using the first representation encoding processing at the time of update until a predetermined condition (hereinafter, referred to as an “update end condition”) regarding end of the update is satisfied.

Here, an example of flow of processing to be executed by the learning unit 10 will be described with reference to the drawings.

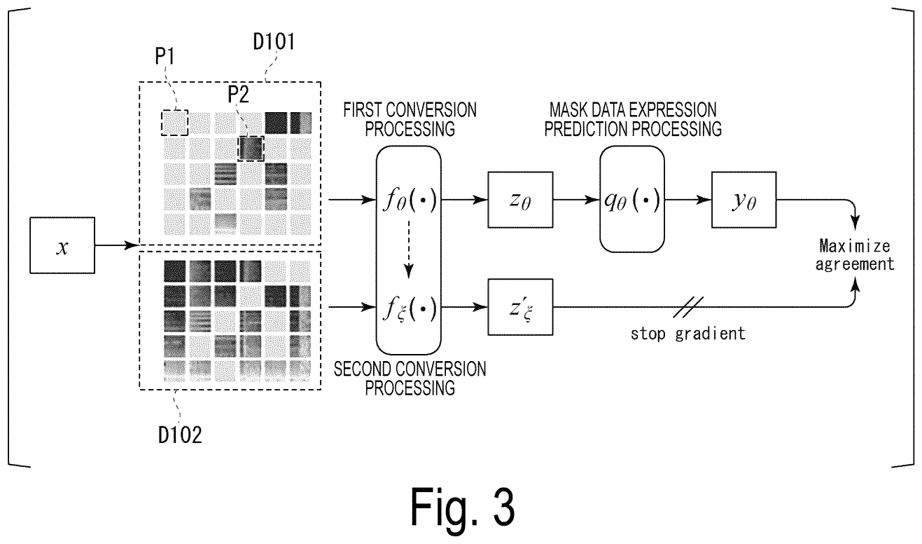

FIG. 3 is an explanatory diagram for explaining outline of flow of the processing to be executed by the learning unit 10 in the embodiment. In FIG. 3, data x is an example of 0-th data. In the example of FIG. 3, the learning unit 10 generates the first data and the second data on the basis of the 0-th data x. Data D101 in the example of FIG. 3 is an example of the first data, and data D102 is an example of the second data.

The data D101 is data in which part of the 0-th data is masked. Note that masking means processing of not setting data to be processed as a target of processing by predetermined other processing. £ In other words, masking means processing of restricting information access. Note that the predetermined other processing is, for example, masked data representation prediction processing. An example of a result of the mask processing will be described by indicating an example of handling of masked data in the next stage. For example, in a case where input data is a sequence of “010101010101” and is converted into data of a sequence of: “**** 0101 **** ” by masking, the data of “*” is not to be processed in the next stage. This is the result of the masking. In this example, “*” is not to be processed in the next stage. In other words, in this example, “*” is an example of data for which information access is restricted.

In FIG. 3, plain patches represent masked patches.

In FIG. 3, patches that are not plain represent unmasked patches. A patch P1 is an example of the plain patch. A patch P2 is an example of the patch that is not plain. A set of masked patches is an example of masked data.

In the example of FIG. 3, the masked data in the first data is data that is not the masked data in the second data. Thus, data including data that is not the masked data in the first data and data that is not the masked data in the second data includes the 0-th data.

However, as described in the description of the second representation encoding processing, all the masked data in the first data does not necessarily have to be data that is not the masked data in the second data. Data other than the masked data in the second data may be part of the masked data in the first data.

Determination as to which data of the 0-th data is to be set as the masked data in the first data may be performed in any manner, for example, randomly. Hereinafter, processing of determining which data of the 0-th data is to be set as the masked data in the first data will be referred to as first masked data determination processing.

As described above, the second data is, for example, data determined as the masked data in the first data. However, as described above, not all the data determined as the masked data in the first data does not necessarily have to be the second data. An example of how to determine the second data in a case where not all but part of the data determined as the masked data in the first data is the second data will be described. In such a case, also for the second data, determination as to which data is to be set as the masked data among the data determined as the masked data in the first data may be performed in any manner, for example, randomly.

Hereinafter, processing of determining which of the data determined as the masked data in the first data is to be set as the masked data will be referred to as second masked data determination processing. Note that, as can be seen from the above description, in a case where the second data is all of the data determined as the masked data in the first data, the second masked data determination processing does not necessarily have to be executed. This is because the data determined as the masked data in the first data is the second data.

The first masked data determination processing and the second masked data determination processing are executed by the learning unit 10 in the example of FIG. 3. However, the first masked data determination processing and the second masked data determination processing do not necessarily have to be executed by the learning unit 10. For example, another device other than the learning device 1 may execute up to generation of the first data and the second data, and the generated first data and second data may be executed by the learning unit 10. In such a case, the learning unit 10 does not execute the first masked data determination processing and the second masked data determination processing. In a case where the second data is all the masked data in the first data, the second masked data determination processing does not have to be executed.

In the example of FIG. 3, the learning unit 10 executes first conversion processing on the first data. A function f_{θ}(·) in FIG. 3 represents first conversion processing. In FIG. 3, Ze represents a result of addition processing. The addition processing is processing of adding the same number of mask tokens as the number of elements belonging to the masked data to the result of the first conversion processing performed on the first data. The mask token is information indicating whether or not an element in the 0-th data belongs to the masked data.

The element belonging to the masked data is an element belonging to the masked data in the first data among the elements of the tensor expressing the 0-th data. Thus, the element belonging to the masked data is, for example, a patch determined as the masked data in the first masked data determination processing.

In other words, the addition processing is processing of adding a vector obtained by adding information indicating a position of the patch Pl in the 0-th data and information indicating the mask token to the result of the first conversion processing. As described above, the result of the addition processing is an example of a result based on the result of the first conversion processing. As in the example of FIG. 3, in a case where the addition processing is executed, the addition processing is executed by the learning unit 10, for example.

In the example of FIG. 3, the learning unit 10 executes the masked data representation prediction processing on the result of the addition processing. In this manner, the addition processing is executed after the execution of the first representation encoding processing and before the masked data representation prediction processing. A function q_{θ}(·) in FIG. 3 represents masked data representation prediction processing. In FIG. 3, y_{θ}represents a result of the masked data representation prediction processing.

In the example of FIG. 3, the learning unit 10 executes second conversion processing on the second data. A function f₈₆ (·) in FIG. 3 represents the second conversion processing. Both the function f_{θ}representing the first conversion processing and the function f_{ξ}representing the second conversion processing are parameterized functions, and values of the parameters are updated by the updating processing.

A symbol of the function f_{θ} means a function f whose parameter value is θ, and a symbol of the function f; means a function f whose parameter value is ξ. Thus, the symbol of the function f_{θ} and the symbol of the function f_{ξ} indicate that the functions of the first conversion processing and the second conversion processing are the same except for the difference in parameters. z′_{ξ} in FIG. 3 represents a result of the second conversion processing.

A result of the masked data representation prediction processing is the target representation of the masked data. The result of the second conversion processing is all or part of the target representation of the masked data. Thus, content of the first representation encoding processing, the masked data representation prediction processing, and the second representation encoding processing is updated on the basis of the conversion error so as to reduce the conversion error, whereby accuracy of converting the representation of the data to be converted into the predetermined representation is improved.

“Maximize agreement” in FIG. 3 indicates that the content of the first representation encoding processing, the masked data representation prediction processing, and the second representation encoding processing is updated so as to reduce the conversion error. In other words, “Maximize agreement” in FIG. 3 indicates that the learning unit 10 executes the updating processing.

“stop gradient” in FIG. 3 indicates that an error back propagation method is not executed when the content of the second representation encoding processing is updated. In the update of the content of the processing, specifically, a value of the parameter included in the function to be executed in the processing is updated. Thus, in the example of the second conversion processing represented by the function f_{ξ}, updating the value of the parameter ξ is updating the content of the second conversion processing. In the example of FIG. 3, the content of the second representation encoding processing is updated not by the error back propagation method but by another updating processing. The other updating processing is, for example, predetermined exponential moving average processing based on the content of the first representation encoding processing.

An example of the exponential moving average processing will be described. Specifically, the content of the first conversion processing and the content of the second conversion processing change as a result of the values of the parameters of the parameterized functions expressing the respective kinds of processing being changed. The parameterized function expressing the first conversion processing is, for example, the function f_{θ}, and the parameterized function expressing the second conversion processing is, for example, the function f_{ξ}. In this case, the value of the parameter ξ after the t-th update obtained by the exponential moving average processing is, for example, ξ[t]=βξ[t-1]+(1-β)θ[t-1]. β is a predetermined constant. β is, for example, 0.99.

In fact, is an ξ[t]=βξ[t-1]+(1-β)θ[t-1] is an amount obtained by integrating the value of θ at the time of each update with a predetermined weight. Thus, the exponential moving average processing is an average value of the values of θ at the time of each update. The average value of the values of θ at the time of each update converges as the update progresses and the accuracy increases. Thus, the exponential moving average processing enables update to ξ with high conversion accuracy. Then, if the value of ξ converges to a value with high conversion accuracy, as a result of the updating processing for reducing the conversion error, the value of θ also converges to a value with high conversion accuracy.

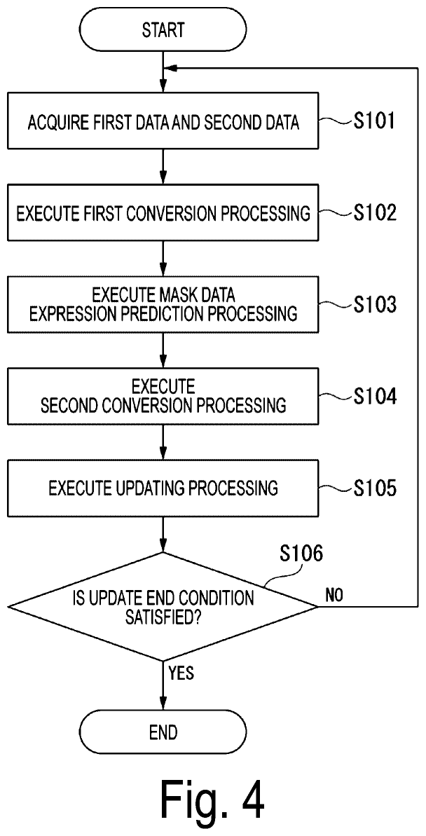

FIG. 4 is a flowchart indicating an example of flow of learning processing to be executed by the learning unit 10 according to the embodiment. The learning unit 10 acquires the first data and the second data (step S101). Next, the learning unit 10 executes the first conversion processing (step S102). Next, the learning unit 10 executes the masked data representation prediction processing (step S103). Next, the learning unit 10 executes the second conversion processing (step S104).

Next, the learning unit 10 executes the updating processing (step S105). Next, the learning unit 10 determines whether or not the update end condition is satisfied (step S106). In a case where the update end condition is satisfied (step S106: YES), the processing ends. On the other hand, in a case where the update end condition is not satisfied (step S106: NO), the processing returns to step S101.

The first representation encoding processing at a time point at which the update end condition is satisfied is the target representation encoding processing. At the time of learning by the learning unit 10, the processing target of the first representation encoding processing is the first data. However, the masked data is not determined in advance and is not the same every time learning is performed. Thus, the first representation encoding processing (that is, the target representation encoding processing) at the time point at which the update end condition is satisfied can convert the representation of the processing target not including the masked data into the target representation with high accuracy. Note that the processing of steps S102 to S103 and the processing of step S104 may be executed in parallel.

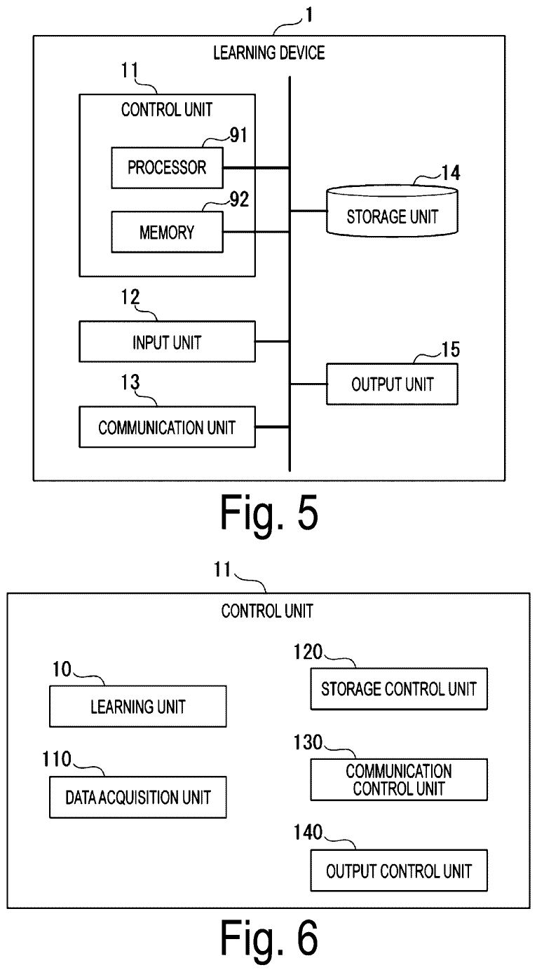

FIG. 5 is a view illustrating an example of a hardware configuration of the learning device 1 according to the embodiment. The learning device 1 includes a control unit 11 including a processor 91 such as a central processing unit (CPU) and a memory 92 connected by a bus, and executes a program. The learning device 1 functions as a device including the control unit 11, an input unit 12, a communication unit 13, a storage unit 14, and an output unit 15 by executing a program.

More specifically, the processor 91 reads out the program stored in the storage unit 14 and stores the readout program in the memory 92. The learning device 1 functions as a device including the control unit 11, the input unit 12, the communication unit 13, the storage unit 14, and the output unit 15 by the processor 91 executing the program stored in the memory 92.

The control unit 11 controls operation of various functional units included in the learning device 1. The control unit 11 includes the learning unit 10. Thus, the control unit 11 executes, for example, the first representation encoding processing, the masked data representation prediction processing, the second representation encoding processing, and the updating processing. The control unit 11 may further execute the first masked data determination processing, the second masked data determination processing, or the addition processing.

The control unit 11 controls, for example, operation of the output unit 15. The control unit 11 records, in the storage unit 14, various kinds of information generated by execution of various kinds of processing such as the first representation encoding processing, the masked data representation prediction processing, the second representation encoding processing, and the updating processing.

The input unit 12 includes an input device such as a mouse, a keyboard, or a touch panel. The input unit 12 may be configured as an interface that connects these input devices to the learning device 1. The input unit 12 receives inputs of various kinds of information to the learning device 1.

The communication unit 13 includes a communication interface for connecting the learning device 1 to an external device. The communication unit 13 communicates with an external device in a wired or wireless manner. The external device is, for example, a transmission source device of the 0-th data. In a case where the external device is a transmission source device of the 0-th data, the communication unit 13 acquires the 0-th data by communication with the transmission source device of the 0-th data.

The external device is, for example, a transmission source device of the original data. In a case where the external device is a transmission source device of the original data, the communication unit 13 acquires the original data by communication with the transmission source device of the original data.

The external device is, for example, a transmission source device of the acoustic signal data. In a case where the external device is a transmission source device of the acoustic signal data, the communication unit 13 acquires the acoustic signal data by communication with the transmission source device of the acoustic signal data.

The external device is, for example, a transmission source device of the natural language data. In a case where the external device is a transmission source device of the natural language data, the communication unit 13 acquires the natural language data by communication with the transmission source device of the natural language data.

The external device is, for example, a transmission source device of the general time-series data in which symbols or numbers other than characters are represented by vectors. In a case where the external device is a transmission source device of the general time-series data, the communication unit 13 acquires the general time-series data by communication with the transmission source device of the general time-series data.

Note that various kinds of information to be input to the communication unit 13 may be input to the input unit 12 instead of the communication unit 13.

The external device is, for example, the conversion device 2. The communication unit 13 communicates with the conversion device 2 to transmit, to the conversion device 2, information indicating the content of the first representation encoding processing (that is, the target representation encoding processing) at the time point at which the update end condition is satisfied.

The storage unit 14 is configured using a computer-readable storage medium device (non-transitory computer-readable recording medium) such as a magnetic hard disk device or a semiconductor storage device. The storage unit 14 stores various kinds of information regarding the learning device 1. The storage unit 14 stores, for example, information input via the input unit 12 or the communication unit 13. The storage unit 14 stores, for example, various kinds of information generated by the operation of the control unit 11.

The output unit 15 outputs various kinds of information. The output unit 15 includes, for example, a display device such as a cathode ray tube (CRT) display, a liquid crystal display, or an organic electro-luminescence (EL) display. The output unit 15 may be configured as an interface that connects these display devices to the learning device 1. The output unit 15 outputs, for example, information input to the input unit 12. The output unit 15 may display, for example, a result of processing of the control unit 11.

FIG. 6 is a view illustrating an example of a configuration of the control unit 11 according to the embodiment. The control unit 11 includes a learning unit 10, a data acquisition unit 110, a storage control unit 120, a communication control unit 130, and an output control unit 140.

The data acquisition unit 110 acquires data to be transmitted to the learning unit 10. The data to be transmitted to the learning unit 10 may be the 0-th data or a set of the first data and the second data. In a case where the data acquisition unit 110 transmits a set of the first data and the second data to the learning unit 10, and the data acquisition unit 110 acquires the 0-th data, the data acquisition unit 110 executes the first masked data determination processing and the second masked data determination processing.

In a case where the input unit 12 or the communication unit 13 acquires the acoustic signal data, the data acquisition unit 110 acquires data which is obtained on the basis of the acoustic signal data acquired by the input unit 12 or the communication unit 13 and which is represented by a tensor as the original data. The data acquisition unit 110 further executes the 0-th data generation processing to acquire the 0-th data on the basis of the obtained original data.

In a case where the input unit 12 or the communication unit 13 acquires the natural language data, the data acquisition unit 110 acquires data which is obtained on the basis of the natural language data acquired by the input unit 12 or the communication unit 13 and which is represented by a tensor as the original data. The data acquisition unit 110 further executes the 0-th data generation processing to acquire the 0-th data on the basis of the obtained original data.

In a case where the input unit 12 or the communication unit 13 acquires the general time-series data in which symbols or numbers other than characters are represented by vectors, the data acquisition unit 110 acquires data which is obtained on the basis of the general time-series data acquired by the input unit 12 or the communication unit 13 and which is represented by a tensor as the original data. The data acquisition unit 110 further executes the 0-th data generation processing to acquire the 0-th data on the basis of the obtained original data.

In a case where the input unit 12 or the communication unit 13 acquires the 0-th data, the data acquisition unit 110 acquires the 0-th data acquired by the input unit 12 or the communication unit 13. In a case where the input unit 12 or the communication unit 13 acquires the set of the first data and the second data, the data acquisition unit 110 acquires the set of the first data and the second data acquired by the input unit 12 or the communication unit 13.

The storage control unit 120 records various kinds of information in the storage unit 14. The communication control unit 130 controls operation of the communication unit 13. The output control unit 140 controls operation of the output unit 15.

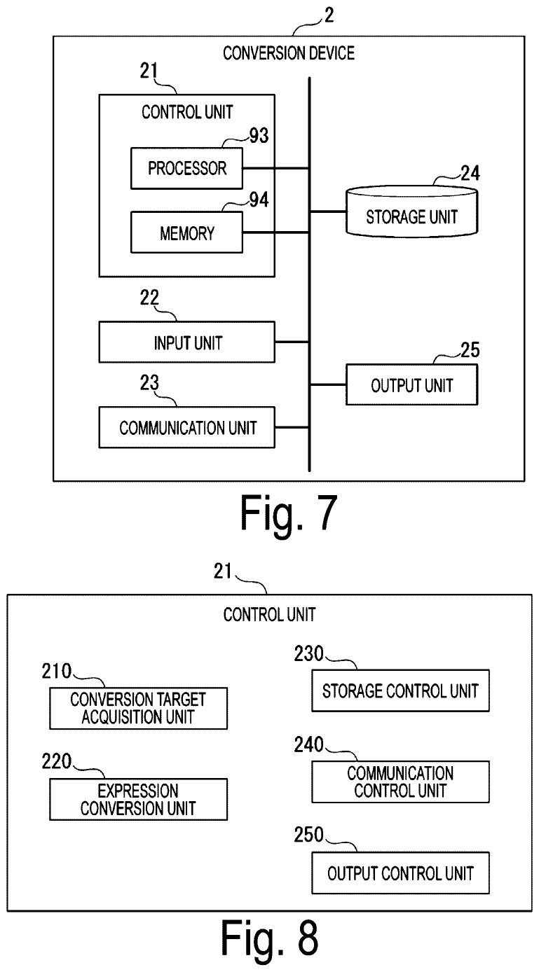

FIG. 7 is a view illustrating an example of a hardware configuration of the conversion device 2 according to the embodiment. The conversion device 2 includes a control unit 21 including a processor 93 such as a CPU and a memory 94 connected via a bus, and executes a program. The conversion device 2 functions as a device including the control unit 21, an input unit 22, a communication unit 23, a storage unit 24, and an output unit 25 by executing a program.

More specifically, the processor 93 reads out the program stored in the storage unit 24, and stores the readout program in the memory 94. The conversion device 2 functions as a device including the control unit 21, the input unit 22, the communication unit 23, the storage unit 24, and the output unit 25 by the processor 93 executing the program stored in the memory 94.

The control unit 21 controls operation of various functional units included in the conversion device 2. The control unit 21 acquires, for example, information indicating the content of the first representation encoding processing (that is, the target representation encoding processing) at a time point at which the update end condition is satisfied, obtained by the learning device 1, and records the information in the storage unit 24.

The control unit 21 executes target representation encoding processing. The target representation encoding processing by the control unit 21 is executed by, for example, the control unit 21 reading out and executing the information indicating the content of the target representation encoding processing recorded in the storage unit 24. The control unit 21 controls, for example, operation of the output unit 25. The control unit 21 records, for example, various kinds of information generated by execution of the target representation encoding processing in the storage unit 24.

The input unit 22 includes an input device such as a mouse, a keyboard, or a touch panel. The input unit 22 may be configured as an interface that connects these input devices to the conversion device 2. The input unit 22 receives inputs of various kinds of information to the conversion device 2.

The communication unit 23 includes a communication interface for connecting the conversion device 2 to an external device. The communication unit 23 communicates with an external device in a wired or wireless manner. The external device is, for example, a transmission source device of data for which representation is to be converted into the target representation. The communication unit 23 acquires the data for which representation is to be converted into the target representation by communication with such an external device. The external device is, for example, the learning device 1. The communication unit 23 acquires information indicating the content of the target representation encoding processing by communication with the learning device 1.

Note that various kinds of information to be input to the communication unit 23 may be input to the input unit 22 instead of the communication unit 23.

The storage unit 24 is configured using a computer-readable storage medium device (non-transitory computer-readable recording medium) such as a magnetic hard disk device or a semiconductor storage device. The storage unit 24 stores various kinds of information regarding the conversion device 2. The storage unit 24 stores, for example, information input via the input unit 22 or the communication unit 23. The storage unit 24 stores, for example, various kinds of information generated by the operation of the control unit 21. The storage unit 24 stores, for example, the content of the target representation encoding processing.

The output unit 25 outputs various kinds of information. The output unit 25 is, for example, a communication interface communicably connected to a device that executes a downstream task. The output unit 25 may include, for example, a display device such as a CRT display, a liquid crystal display, or an organic EL display. The output unit 25 may be configured as an interface that connects these display devices to the conversion device 2. The output unit 25 outputs, for example, information input to the input unit 22. The output unit 25 may output, for example, an execution result of the target representation encoding processing.

FIG. 8 is a view illustrating an example of a configuration of the control unit 21 according to the embodiment. The control unit 21 includes a conversion target acquisition unit 210, an representation conversion unit 220, a storage control unit 230, a communication control unit 240, and an output control unit 250. The conversion target acquisition unit 210 acquires data which is input to the communication unit 23 and which is data for which representation is to be converted into the target representation.

The representation conversion unit 220 converts the representation of the data acquired by the conversion target acquisition unit 210 using the target representation encoding processing. According to the data acquired by the conversion target acquisition unit 210, the representation conversion unit 220 may execute various kinds of processing executed by the data acquisition unit 110, such as the 0-th data generation processing, so that the target representation encoding processing can be executed.

The storage control unit 230 records various kinds of information in the storage unit 24. The communication control unit 240 controls operation of the communication unit 23. The output control unit 250 controls operation of the output unit 25.

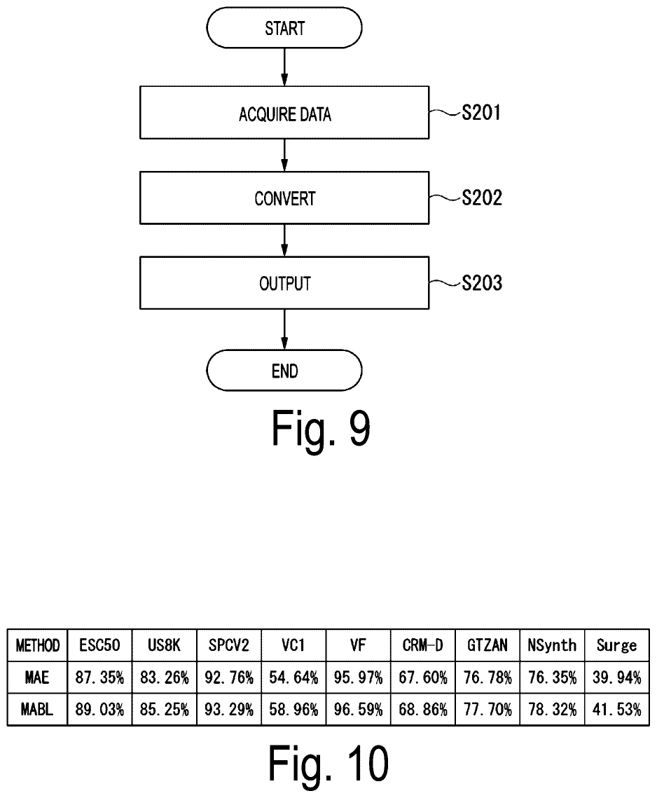

FIG. 9 is a flowchart indicating an example of flow of processing to be executed by the conversion device 2 according to the embodiment. The conversion target acquisition unit 210 acquires the data for which representation is to be converted into the target representation input to the communication unit 23 (step S201). Next, the representation conversion unit 220 converts the representation of the data acquired in step S201 using the target representation encoding processing (step S202). Next, the output control unit 250 controls the operation of the output unit 25 to cause the output unit 25 to output the result of step S202 (step S203).

Note that an output destination by the output unit 25 may be, for example, a device that executes a downstream task.

### Experiment Results

With reference to FIG. 10, results of experiments for executing downstream tasks on data subjected to representation conversion using the target representation encoding processing will be described. In the experiments, as the downstream tasks, a task of classifying environmental sound, a task of identifying a voice command word, a task of identifying a speaker, a task of classifying voice language, a task of classifying emotion included in voice, a task of classifying a music genre, a task of classifying a musical instrument of musical sound, and a task of classifying a pitch of musical sound were performed.

FIG. 10 is a view indicating an example of results of experiments in the embodiment. Both “ESC50” and “US8K” indicate the task of classifying environmental sound. “SPCV2” indicates the task of identifying a voice command word. “VC1” indicates the task of identifying a speaker. “VE” indicates the task of classifying voice language. “CRM-D” indicates the task of classifying emotion included in the voice. “GTZAN” indicates the task of classifying a music genre. “NSynth” indicates the task of classifying a musical instrument of musical sound. “Surge” indicates the task of classifying a pitch of the musical sound.

“MAE” indicates masked autoencoders (MAE) which is an existing technology. “MABL” indicates the target representation encoding processing. The results of FIG. 10 indicate that accuracy of the downstream tasks using the result of the conversion of the representation by the target representation encoding processing is higher than accuracy of the downstream tasks using the result of the conversion of the representation by the MAE for any downstream task.

For example, for “ESC50”, the accuracy of the downstream task “ESC50” using the result of conversion of the representation by the MAE is 87.35%, whereas the accuracy of the downstream task “ESC50” using the result of conversion of the representation by the target representation encoding processing is 89.03%.

For example, for “VC1”, the accuracy of the downstream task “VC1” using the result of conversion of the representation by the MAE is 54.64%, whereas the accuracy of the downstream task “VC1” using the result of conversion of the representation by the target representation encoding processing is 58.96%.

The learning device 1 configured as described above performs learning of the first representation encoding processing so as to reduce a difference between the representation of the masked data obtained on the basis of the data obtained by removing the masked data and the representation of the masked data obtained on the basis of part or all of the masked data.

This is different from MAE in which a patch image of the masked portion is restored from representation of the unmasked patch output by a model and a loss is calculated using a difference between the input signal and the restored signal. In the case of MAE, restoration (that is, decoding) is further performed after the conversion of the representation, and thus, an error may occur in the information in association with the restoration. Thus, unlike the MAE, the learning device 1 that does not perform restoration at the time of learning can improve accuracy of converting representation of the data to be converted into the predetermined representation (that is, the target representation).

The learning by the learning device 1 is also different from data2vec. In the case of data2vec, all the patches are input to acquire the target representation of the moving average model, and only the masked portion is used as a training signal. Thus, information of the unmasked portion is included in the target representation of the masked portion. Note that the masked portion is masked data, and the unmasked portion is data other than the masked data in the 0-th data. As a result, in data2vec, learning depending on the information of the unmasked portion is performed, and in some cases, learning which improves accuracy of representation conversion is not performed.

On the other hand, in the learning by the learning device 1, part or all of the target representation of the masked data is obtained without using data that is not the masked data in the 0-th data in the second representation encoding processing. Then, the result of the second representation encoding processing is compared with the result of the masked data representation prediction processing. In other words, in the learning by the learning device 1, the result of the second representation encoding processing is used as the training signal. As described above, the result of the second representation encoding processing does not include the information of the unmasked portion. Thus, unlike data2vec, the learning device 1 can improve accuracy of converting the representation of the data to be converted into the predetermined representation.

### Modifications

In the first data, a ratio of the masked data may be 50% of the data included in the 0-th data. In a case where the ratio of the masked data is 50%, the accuracy of converting the representation of the data to be converted into the predetermined representation is improved as compared with a case where the ratio is not 50% for the following reason (hereinafter, referred to as “first reason”).

### First Reason

A conversion error of the target representation output by each of the first representation encoding processing and the second representation encoding processing is reduced by modeling the entire data including each piece of masked data. Modeling is easy if there is less masked data, and difficult if there is more masked data. Target representation processed at different difficulty levels has different amounts of information available for modeling and has different characteristics. By setting the ratio of the masked data to 50%, the first data and the second data become the target representation having the same characteristics, for which processing has been performed on the basis of the same information amount, and the conversion error is optimal for learning better modeling.

In the first data, the ratio of data that is not the masked data may be 50% or less of the data included in the 0-th data, and the ratio of data that is part of the masked data and is used for the second representation encoding processing may also be 50% or less of the data included in the 0-th data. The difficulty of modeling is higher than that in such a case, and thus, the accuracy of converting the representation of the data to be converted into the predetermined representation is improved as compared with the other case.

Each of the learning device 1 and the conversion device 2 may be implemented using a plurality of information processing devices communicably connected via a network. In this case, respective functional units included in the learning device 1 and the conversion device 2 may be implemented in a distributed manner in a plurality of information processing devices.

Note that the learning device 1 and the conversion device 2 do not necessarily have to be mounted as different devices. The learning device 1 and the conversion device 2 may be implemented as one device having both functions, for example.

All or some of the respective functions of the representation conversion system 100, the learning device 1, and the conversion device 2 may be implemented by using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via an electrical communication line.

Although the embodiment of the present invention has been described in detail with reference to the drawings, the specific configuration is not limited to the embodiment, and includes design, and the like, within a range not departing from the gist of the present invention.

### REFERENCE SIGNS LIST

100 Representation conversion system
1 Learning device
2 Conversion device
10 Learning unit
11 Control unit
12 Input unit
13 Communication unit
14 Storage unit
15 Output unit
110 Data acquisition unit
120 Storage control unit
130 Communication control unit
140 Output control unit
21 Control unit
22 Input unit
23 Communication unit
24 Storage unit
25 Output unit
210 Conversion target acquisition unit
220 Representation conversion unit
230 Storage control unit
240 Communication control unit
250 Output control unit
91 Processor
92 Memory
93 Processor
94 Memory

1. A learning device comprising:
a processor;
a storage medium having computer program instructions stored thereon, wherein the computer program instruction, when executed by the processor, perform processing of:
obtaining, by learning, target representation encoding processing that is processing of converting representation of data to be converted into target representation that is predetermined representation determined in advance,
wherein the processor
executes first representation encoding processing of converting representation of a processing target into target representation using first data that is data obtained by removing masked data that is part of 0-th data from the 0-th data that is data represented by a tensor as the processing target, masked data representation prediction processing of predicting target representation of the masked data on a basis of a result of the first representation encoding processing, second representation encoding processing of converting representation of second data into target representation on a basis of the second data that is part or all of the masked data, and updating processing of updating content of the first representation encoding processing, the masked data representation prediction processing, and the second representation encoding processing so as to reduce a difference between a result of the masked data representation prediction processing and a result of the second representation encoding processing, and
the first representation encoding processing at a time point at which a predetermined condition regarding end of update is satisfied is the target representation encoding processing.

2. The learning device according to claim 1,
wherein after execution of the first representation encoding processing and before the masked data representation prediction processing, the processor executes addition processing of adding the same number of mask tokens as the number of elements belonging to the masked data, to the result of the first representation encoding processing, the mask tokens indicating whether or not the elements in the 0-th data belong to the masked data, and
a processing target of the masked data representation prediction processing is a result of the addition processing.

3. The learning device according to claim 1,
wherein a ratio of the masked data in the first data is 50% of data included in the 0-th data.

4. The learning device according to claim 1,
wherein in the first data, a ratio of data that is not the masked data is 50% or less of data included in the 0-th data, and a ratio of data that is part of the masked data and is used for the second representation encoding processing is also 50% or less of the data included in the 0-th data.

5. (canceled)

6. A learning method comprising:
obtaining, by learning, target representation encoding processing that is processing of converting representation of data to be converted into target representation that is predetermined representation determined in advance,
wherein
first representation encoding processing of converting representation of a processing target into target representation using first data that is data obtained by removing masked data that is part of 0-th data from the 0-th data that is data represented by a tensor as the processing target, masked data representation prediction processing of predicting the target representation of the masked data on a basis of a result of the first representation encoding processing, second representation encoding processing of converting representation of second data into target representation on a basis of the second data that is part or all of the masked data, and updating processing of updating content of the first representation encoding processing, the masked data representation prediction processing, and the second representation encoding processing so as to reduce a difference between a result of the masked data representation prediction processing and a result of the second representation encoding processing, are executed, and
the first representation encoding processing at a time point at which a predetermined condition regarding end of update is satisfied is the target representation encoding processing.

7. (canceled)

8. A non-transitory computer readable medium which stores a program for causing a computer to function as the learning device according to claim 1.
